(19) United States
(12) Patent Application Publication
(10) Pub. No.: US 2002/0075294 A1
(43) Pub. Date: Jun. 20, 2002

(54) Digital broadcast receiving device and digital broadcast receiving method

(76) Inventors: Heikan Izumi, Tokyo (JP); Toyoshi Makino, Tokyo (JP)

Correspondence Address: BIRCH STEWART KOLASCH & BIRCH, PO BOX 747, FALLS CHURCH, VA, 22040-0747, US

(21) Appl. No.: 09/971,029

(22) Filed: Oct. 5, 2001

(30) Foreign Application Priority Data
Dec. 15, 2000 (JP) 2000-382631

(51) Int. Cl. G09G 5/00

(52) U.S. Cl. 345/718

(57) ABSTRACT

A receiving board is set into a personal computer, a digital broadcast signal is received in the receiving board, and a high-definition television (HDTV) picture of the digital broadcast signal is decoded in the receiving board. The HDTV picture or an output picture of the personal computer is selected in a selector switch of the personal computer, and the selected HDTV picture or the selected output picture of the personal computer is directly displayed in a CRT of the personal computer or an HDTV monitor of a high-definition television set without passing through a peripheral component interconnect (PCI) bus of the personal computer. Therefore, because the HDTV picture does not pass through the PCI bus, a user can view the HDTV picture of the digital broadcast signal in the CRT of the personal computer in real time.

### BACKGROUND OF THE INVENTION

1. Field of the Invention

The present invention relates to a digital broadcast receiving device and a digital broadcast receiving method in which a digital broadcast signal including a picture of high-definition television (hereinafter, called HDTV) is received and the HDTV picture is decoded.

2. Description of Related Art

FIG. 4 is a block diagram showing the configuration of a conventional digital broadcast receiving device disclosed in Published Unexamined Japanese Patent Application No. H11-112370 (1999). In FIG. 4, 1 indicates a connector inserted into a slot of a personal computer (not shown). 2 indicates an antenna. 3 indicates a tuner for receiving a digital broadcast signal including an HDTV picture through the antenna 2. 4 indicates a decoding circuit for decoding the HDTV picture of the digital broadcast signal received in the tuner 3. 5 indicates an output circuit for outputting the HDTV picture decoded in the decoding circuit 4 as audio and visual data. 6 indicates a storing circuit for storing the HDTV picture output from the output circuit 5. 7 indicates a control circuit for controlling the antenna 2, the tuner 3, the decoding circuit 4, the output circuit 5 and the storing circuit 6 and controlling the storing circuit 6 to output the HDTV picture to a peripheral component interconnect (PCI) bus (not shown) of the personal computer. The conventional digital broadcast receiving device is assembled on a board.

Next, an operation of the conventional digital broadcast receiving device will be described below.

When the conventional digital broadcast receiving device assembled on a board is inserted into a slot of a personal computer, a digital broadcast signal including an HDTV picture is received, the HDTV picture of the digital broadcast signal is decoded and is output to the PCI bus of the personal computer.

In detail, when the HDTV picture of the digital broadcast signal is received in the tuner 3 through the antenna 2, the HDTV picture is decoded in the decoding circuit 4, and the HDTV picture is stored in the storing circuit 6. Thereafter, when an output request of a picture is sent from the personal computer and is received in the control circuit 7, the control circuit 7 controls the storing circuit 6 to output the HDTV picture to the connector 1, and the HDTV picture stored in the storing circuit 6 is output to the PCI bus of the personal computer. Therefore, it is possible to display the HDTV picture of the digital broadcast signal in a display of the personal computer.

However, because the HDTV picture has a large quantity of picture data, there is high probability that an overflow occurs in the PCI bus due to the HDTV picture. Therefore, a problem has arisen that the HDTV picture transmitted through the PCI bus cannot be displayed in real time.

### SUMMARY OF THE INVENTION

An object of the present invention is to provide, with due consideration to the drawbacks of the conventional digital broadcast receiving device, a digital broadcast receiving device and a digital broadcast receiving method in which an HDTV picture of a digital broadcast signal is displayed in real time.

The object is achieved by the provision of a digital broadcast receiving device comprising receiving means, arranged in a personal computer, for receiving a high-definition television picture of a digital broadcast signal and decoding the high-definition television picture, and displaying means, arranged in the personal computer, for selecting either the high-definition television picture decoded by the receiving means or an output picture of the personal computer and displaying the selected high-definition television picture or the selected output picture on a display.

In the above configuration, the high-definition television picture of the digital broadcast signal is sent to a display of the personal computer without passing through a peripheral component interconnect bus and is displayed on the display. In this case, though a data quantity of the high-definition television picture is considerably larger than a normal picture conforming to NTSC (National Television System Committee) system or the like, because the high-definition television picture does not pass through the peripheral component interconnect bus corresponding to a low data transfer rate, the high-definition television picture can be displayed on the display in real time.

It is preferred that the receiving means is arranged on a board and is set to the personal computer.

Therefore, the high-definition television picture can be displayed on a display of the personal computer.

It is preferred that the receiving means is arranged in a card and is set to the personal computer.

Therefore, the high-definition television picture can be displayed on a display of the personal computer.

It is preferred that the high-definition television picture or the output picture of the personal computer is displayed on a monitor of the personal computer by the display means.

Therefore, the high-definition television picture can be displayed on the monitor of the personal computer.

It is preferred that the high-definition television picture or the output picture of the personal computer is displayed on a monitor of a high-definition television set by the display means.

Therefore, the high-definition television picture can be displayed on the monitor of the high-definition television set.

It is preferred that the digital broadcast receiving device further comprises a central processing unit, arranged in the personal computer, for controlling the receiving means and the displaying means to display the high-definition television picture decoded by the receiving means on the display of the displaying means.

Therefore, the high-definition television picture can be reliably displayed in real time.

It is preferred that the digital broadcast receiving device further comprises a peripheral component interconnect bus arranged in the personal computer, and contents of a data broadcast signal multiplexed in the digital broadcast signal are output by the receiving means to the central processing unit through the peripheral component interconnect bus.

Therefore, a user can view the data broadcast by using the personal computer.

It is preferred that the digital broadcast receiving device further comprises a peripheral component interconnect bus arranged in the personal computer, wherein an electronic program guide multiplexed in the digital broadcast signal is output by the receiving means to the central processing unit through the peripheral component interconnect bus.

Therefore, a user can select a favorite program by using the personal computer.

It is preferred that the digital broadcast receiving device further comprises a peripheral component interconnect bus arranged in the personal computer, and a graphic card, arranged in the personal computer, for storing the output picture of the-personal computer. The high-definition television picture is converted into a normal picture by the receiving means and is stored in the graphic card through the peripheral component interconnect bus, and the normal picture stored in the graphic card is displayed on the display of the displaying means.

Therefore, a user can view the normal picture corresponding to the high-definition television picture at his or her favorite time.

The object is achieved by the provision of a digital broadcast receiving method comprising the steps of setting a board, on which an element having a data receiving function and a data decoding function is arranged, into a personal computer, receiving a digital broadcast signal in the board, decoding a high-definition television picture of the digital broadcast signal in the board, selecting either the decoded high-definition television picture or an output picture of the personal computer, and displaying the selected high-definition television picture or the selected output picture on a display.

Therefore, the high-definition television picture can be displayed in real time.

The object is achieved by the provision of a digital broadcast receiving method comprising the steps of setting a card having a data receiving function and a data decoding function into a personal computer, receiving a digital broadcast signal in the card, decoding a high-definition television picture of the digital broadcast signal in the card, selecting either the decoded high-definition television picture or an output picture of the personal computer, and displaying the selected high-definition television picture or the selected output picture on a display.

Therefore, the high-definition television picture can be displayed in real time.

### BRIEF DESCRIPTION OF THE DRAWINGS

FIG. 1 is a block diagram showing the configuration of a digital broadcast receiving device according to a first embodiment of the present invention;

FIG. 2 is a flow chart showing a method of receiving a digital broadcast signal according to the first embodiment;

FIG. 3 is an explanatory view showing the digital broadcast signal demultiplexed to audio data, HDTV picture, contents of data broadcast signal and electronic program guide.

FIG. 4 is a block diagram showing the configuration of a conventional digital broadcast receiving device.

### DETAILED DESCRIPTION OF THE PREFERRED EMBODIMENTS

Embodiments of the present invention will now be described with reference to the accompanying drawings.

Embodiment 1

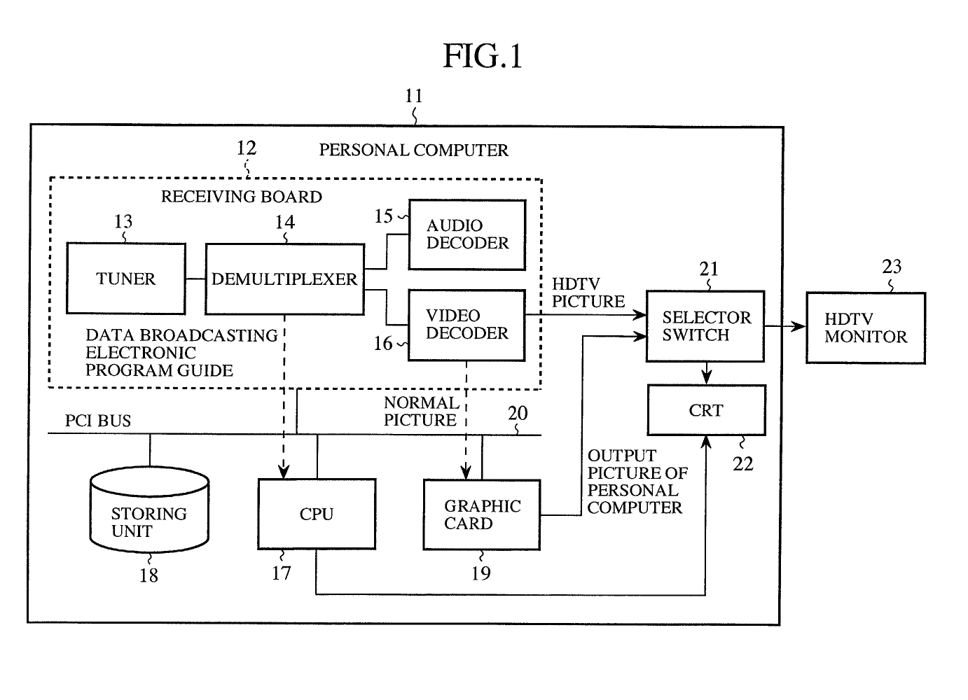

FIG. 1 is a block diagram showing the configuration of a digital broadcast receiving device according to a first embodiment of the present invention.

In FIG. 1, 11 indicates a personal computer. 12 indicates a receiving board (or receiving means), set into a slot of the personal computer 11, for-receiving a digital broadcast signal of programs such as an HDTV picture, audio data, contents of a data broadcast signal and an electronic program guide and decoding the programs of the digital broadcast signal. In the receiving board 12, 13 indicates a tuner for receiving the digital broadcast signal. 14 indicates a demultiplexer for demultiplexing a program of the HDTV picture from the digital broadcast signal. 15 indicates an audio decoder for decoding the audio data of the digital broadcast signal. 16 indicates a picture decoder for decoding the HDTV picture of the digital broadcast signal. The tuner 13, the demultiplexer 14, the audio decoder 15 and the picture decoder 16 are mounted on the receiving board 12.

Also, in the personal computer 11, 18 indicates a storing unit for storing data and calculation results in the personal computer 11. 19 indicates a graphic card for producing an output picture of the personal computer 11. 20 indicates a peripheral component interconnect (PCI) bus of the personal computer 11. A data transfer rate of the PCI bus 20 is low, and the HDTV picture cannot be transmitted through the PCI bus 20 in real time. 21 indicates a selector switch for selecting either the HDTV picture decoded in the picture decoder 16 of the receiving board 12 or the output picture of the personal computer 11 produced in the graphic card 19. 17 indicates a central processing unit (CPU) for controlling the receiving board 12, the storing unit 18, the graphic card 19 and the selector switch 21. 22 indicates a cathode-ray tube (CRT) for displaying the HDTV picture or the output picture selected in the selector switch 21.

Also, 23 indicates an HDTV monitor of a high-definition television set. A display means comprises the selector switch 21, the CRT 22 and the HDTV monitor 23.

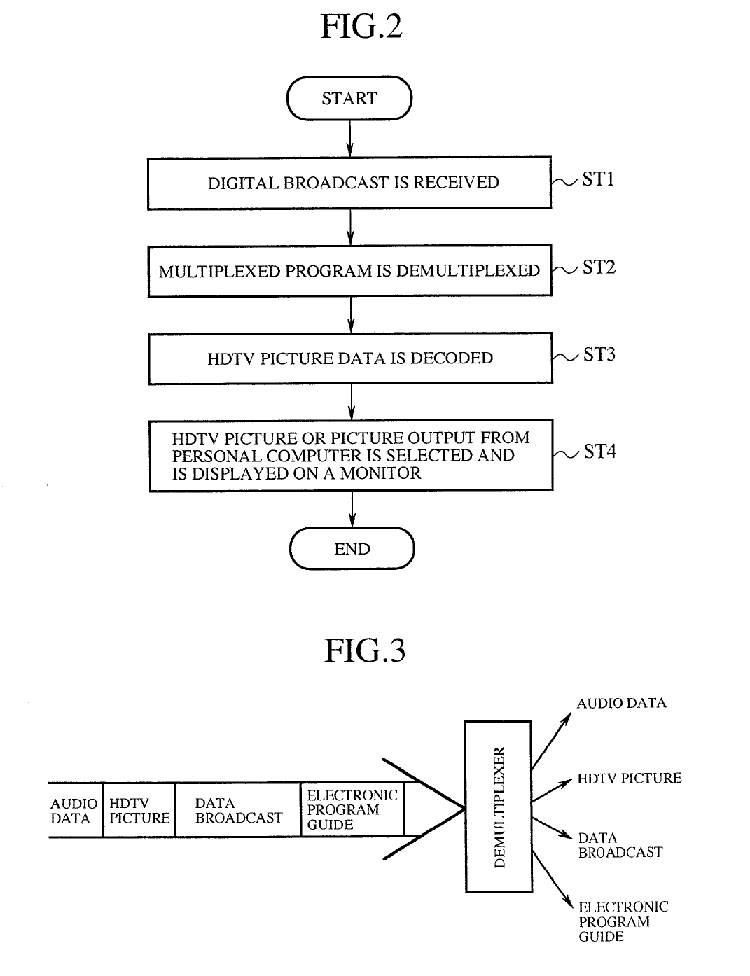

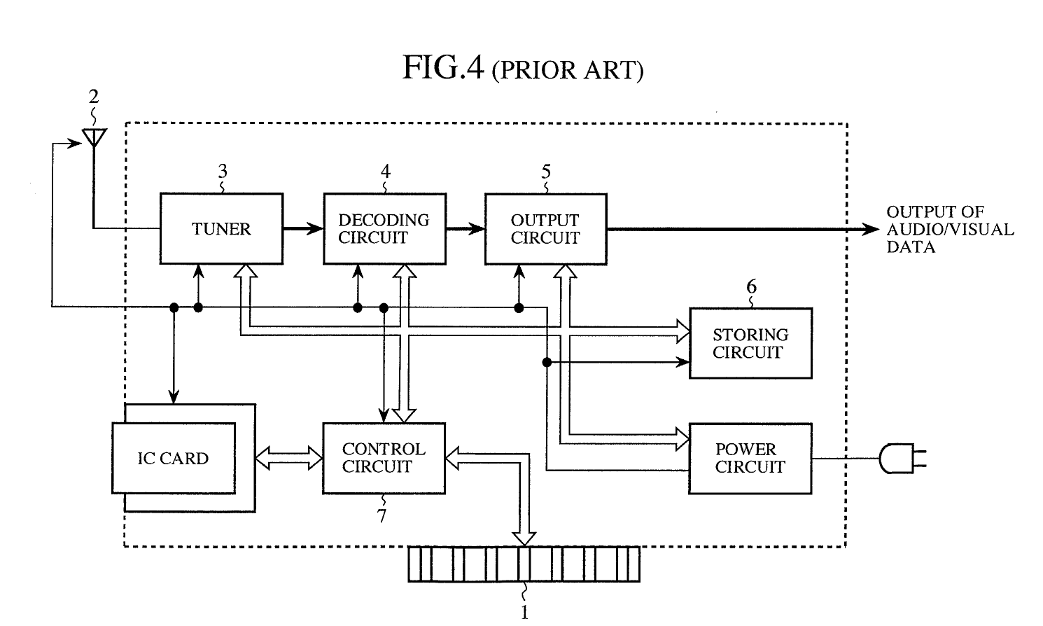

Next, an operation of the digital broadcast receiving device will be described below with reference to FIG. 2 and FIG. 3.

FIG. 2 is a flow chart showing a method of receiving a digital broadcast signal according to the first embodiment, and FIG. 3 is an explanatory view showing the digital broadcast signal demultiplexed to audio data, HDTV picture, contents of data broadcast signal and electronic program guide.

When a digital broadcast signal is received in the tuner 13 of the receiving board 12 (step ST1), programs multiplexed in the digital broadcast signal are demultiplexed in the demultiplexer 14 (step ST2).

In detail, as shown in FIG. 3, because programs such as an HDTV picture, audio data, contents of a data broadcast signal and an electronic program guide are multiplexed in the digital broadcast signal, the programs of the digital broadcast signal is demultiplexed to an HDTV picture, audio data, contents of a data broadcast signal and an electronic program guide.

Thereafter, in the picture decoder 16, the HDTV picture is received, the HDTV picture is decoded, and the HDTV picture is directly output to the selector switch 21 without passing through the PCI bus 20 (step ST3).

Also, an output picture of the personal computer 11 is produced in the graphic card 19, and the output picture of the personal computer 11 is sent to the selector switch 21 under the control of the CPU 17. In the selector switch 21, either the HDTV picture sent from the picture decoder 16 or the output picture of the personal computer 11 sent from the graphic card 19 is selected, and the HDTV picture or the output picture selected in the selector switch 21 is directly output to the CRT 22 or the HDTV monitor 23 without passing through the PCI bus 20 (step ST4).

Therefore, the HDTV picture is directly displayed on the CRT 22 of the personal computer 11 or the HDTV monitor 23 of a high-definition television set without passing through the PCI bus 20. Here, because a degree of resolution in the CRT 22 is almost the same as or higher than that in the HDTV monitor 23, the HDTV picture can be clearly displayed on the CRT 22 of the personal computer 11.

As is described above, in the first embodiment, the HDTV picture of the digital broadcast signal is received and decoded in the receiving board 12, and the HDTV picture or the output picture of the personal computer 11 is selected in the selector switch 21 and is output to the CRT 22 of the personal computer 11. Therefore, the HDTV picture of the digital broadcast signal can be displayed on the CRT 22 of the personal computer 11 without passing through the PCI bus 20. Accordingly, the HDTV picture can be displayed in real time.

Also, in the first embodiment, a tuner or a monitor for the digital HDTV broadcasting is not additionally arranged in the digital broadcast receiving device, but the receiving board 12 is set into the personal computer 11. Accordingly, a user can entertain the HDTV picture displayed on the CRT 22 or the HDTV monitor 23 without additionally using a high expensive device such as a tuner or a monitor.

In the first embodiment, the receiving board 12 is inserted into a slot of the personal computer 11. However, it is applicable that a personal computer card having the same function as that of the receiving board 12 be inserted into a slot of the personal computer 11. In the personal computer card, semiconductor integrated circuits are arranged.

Embodiment 2

In the first embodiment, the HDTV picture is displayed on the CRT 22 or the HDTV monitor 23. In contrast, in a second embodiment, the HDTV picture is compressed to a normal picture conforming to NTSC (National Television System Committee) system, PAL (phase alternating by line) system or SECAM (Sequential Couleur a Memoire) color television system, the normal picture is recorded in the graphic card 19 through the PCI bus 20, and the normal picture recorded in the graphic card 19 is selected in the selector switch 21 under the control of the CPU 17 and is displayed on the CRT 22 or the HDTV monitor 23.

Accordingly, in the second embodiment, because a data quantity of the normal picture is considerably smaller than that of the HDTVpicture, the normal picture can be reliably recorded in the graphic card 19 through the PCI bus 20, and a user can entertain the normal picture displayed on the CRT 22 or the HDTV monitor 23 at any time when the user desires to view the normal picture.

Embodiment 3

In the first embodiment, the HDTV picture is demultiplexed from the digital broadcast signal in the demultiplexer 14. In contrast, in a third embodiment, contents of a data broadcast signal and an electronic program guide are demultiplexed from the digital broadcast signal in the demultiplexer 14, and the contents of the data broadcast signal and the electronic program guide are sent to the CPU 17 through the PCI bus 20. Thereafter, the contents of the data broadcast signal and the electronic program guide are processed in the CPU 17 and are stored in a memory of the CPU 17. Thereafter, the contents of the data broadcast signal and the electronic program guide of the CPU 17 are sent to the CRT 22 and are displayed on the CPU 17.

Accordingly, in the third embodiment, a user can select a favorite program listed in the electronic program guide, and the user can entertain the contents of the data broadcast signal corresponding to the favorite program.

What is claimed is:

1. A digital broadcast receiving device comprising:
receiving means, arranged in a personal computer, for receiving a high-definition television picture of a digital broadcast signal and decoding the high-definition television picture; and
displaying means, arranged in the personal computer, for selecting either the high-definition television picture decoded by the receiving means or an output picture of the personal computer and displaying the selected high-definition television picture or the selected output picture on a display.

2. A digital broadcast receiving device according to claim 1, wherein the receiving means is arranged on a board and is set to the personal computer.

3. A digital broadcast receiving device according to claim 1, wherein the receiving means is arranged in a card and is set to the personal computer.

4. A digital broadcast receiving device according to claim 1, wherein the high-definition television picture or the output picture of the personal computer is displayed on a monitor of the personal computer by the display means.

5. A digital broadcast receiving device according to claim 1, wherein the high-definition television picture or the output picture of the personal computer is displayed on a monitor of a high-definition television set by the display means.

6. A digital broadcast receiving device according to claim 1, further comprising
a central processing unit, arranged in the personal computer, for controlling the receiving means and the displaying means to display the high-definition television picture decoded by the receiving means on the display of the displaying means.

7. A digital broadcast receiving device according to claim 6, further comprising
a peripheral component interconnect bus arranged in the personal computer, wherein contents of a data broadcast signal multiplexed in the digital broadcast signal are output by the receiving means to the central processing unit through the peripheral component interconnect bus.

8. A digital broadcast receiving device according to claim 6, further comprising
a peripheral component interconnect bus arranged in the personal computer, wherein an electronic program guide multiplexed in the digital broadcast signal is output by the receiving means to the central processing unit through the peripheral component interconnect bus.

9. A digital broadcast receiving device according to claim 1, further comprising
a peripheral component interconnect bus arranged in the personal computer; and
a graphic card, arranged in the personal computer, for storing the output picture of the personal computer, wherein the high-definition television picture is converted into a normal picture by the receiving means and is stored in the graphic card through the peripheral component interconnect bus, and the normal picture stored in the graphic card is displayed on the display of the displaying means.

10. A digital broadcast receiving method comprising the steps of:
setting a board, on which an element having a data receiving function and a data decoding function is arranged, into a personal computer;
receiving a digital broadcast signal in the board;
decoding a high-definition television picture of the digital broadcast signal in the board;
selecting either the decoded high-definition television picture or an output picture of the personal computer; and
displaying the selected high-definition television picture or the selected output picture on a display.

11. A digital broadcast receiving method comprising the steps of:
setting a card having a data receiving function and a data decoding function into a personal computer;
receiving a digital broadcast signal in the card;
decoding a high-definition television picture of the digital broadcast signal in the card;
selecting either the decoded high-definition television picture or an output picture of the personal computer; and
displaying the selected high-definition television picture or the selected output picture on a display.
